(19) United States
(12) Patent Application Publication
(10) Pub. No.: US 2002/0097695 A1
(43) Pub. Date: Jul. 25, 2002

(54) Wireless network having a selection of transport format combinations

(76) Inventor: Christoph Herrmann, Aachen (DE)

Correspondence Address: Philips Electronics North America Corporation, 580 White Plains Road, Tarrytown, NY, 10591, US

(21) Appl. No.: 10/046,635

(22) Filed: Jan. 14, 2002

(30) Foreign Application Priority Data
Jan. 15, 2001 (DE) 10101703.0

(51) Int. Cl. H04Q 7/00

(52) U.S. Cl. 370/329; 370/466

(57) ABSTRACT

The invention relates to a wireless network having a radio network controller and a plurality of assigned terminals which are provided each for transmitting transport blocks formed from packet units of a logic channel on a transport channel which is assigned a transmission time interval from at least one radio frame, and which is active when the beginning of its transmission time interval and of a radio frame correspond. The radio network controller or a terminal is provided for the purpose of forming at least one transport format combination, which specifies the transport blocks provided for transmission on each transport channel, so that a required transport format combination is to be determined which includes as transport format the respective packet units awaiting a transmission in the assigned transport channel, and that the transport format combination that corresponds to the required transport format combination or comes closest to it is to be selected from a set of prescribed transport format combinations.

The invention relates to a wireless network having a radio network controller and a plurality of assigned terminals which are provided in each case for transmitting useful data on logic channels having a different priority, which are mapped onto at least one transport channel.

A wireless network which describes the function of the MAC layer (MAC=Medium Access Control) is known from 3rd Generation Partnership Project (3GPP); Technical Specification Group (TSG) RAN; Working Group 2 (WG2); Radio Interface Protocol Architecture; TS 25.302 V3.6.0). The packet units formed in the RLC layer (RLC=Radio Link Control) are packed in the MAC layer in transport blocks which are transmitted by the radio network controller from the physical layer over physical channels to a terminal, or vice versa. Apart from such a multiplex or demultiplex function, the MAC layer has the function of selecting suitable transport format combinations (=TFC). A transport format combination constitutes a combination of transport formats for each transport channel. The transport format combination describes, inter alia, how the transport channels are multiplexed in the physical layer in a physical channel.

The invention is based on the object of creating a wireless network which specifies a selection process for finding suitable transport format combinations.

The object is achieved according to the invention by a wireless network having a radio network controller and a plurality of assigned terminals, which are provided over each for transmitting transport blocks formed from packet units of a logic channel over a transport channel which is assigned a transmission time interval from at least one radio frame and which is active when the beginning of its transmission time interval and of a radio frame correspond, and which are provided for forming at least one transport format combination which specifies the transport blocks provided for transmission on each transport channel, so that

a required transport format combination is to be determined, which includes as a transport format the respective packet units awaiting transmission in the assigned transport channel, and

the transport format combination which corresponds to the required transport format combination or comes closest to it is to be selected from a set of predefined transport format combinations.

The wireless network according to the invention proposes a two-stage process for finding a suitable transport format combination. Firstly, a required transport format combination is determined which includes precisely the transport formats or specifies transport blocks awaiting transmission in the buffers assigned to the logic channels. A transport format combination is found if a transport format combination is present which corresponds to the required transport format combination. In the other case, it is necessary to find a transport format combination which comes closest to the required transport format combination.

The dependent claims set forth various options for finding a transport format combination which comes closest to the required transport format combination.

Examples of embodiment of the invention are explained in more detail below with the aid of the figures, in which:

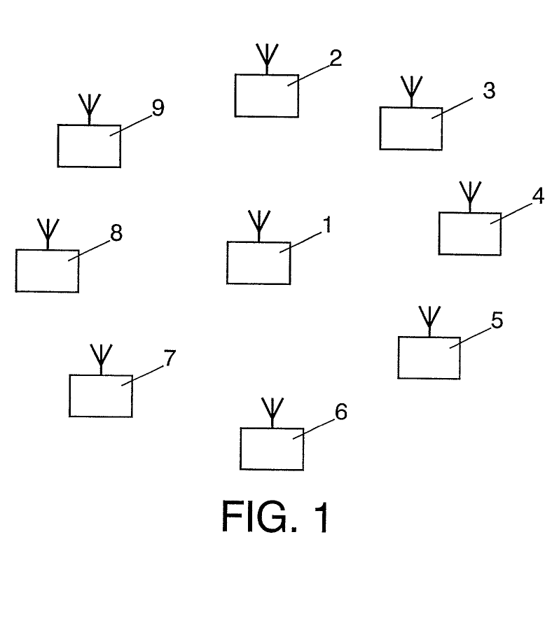

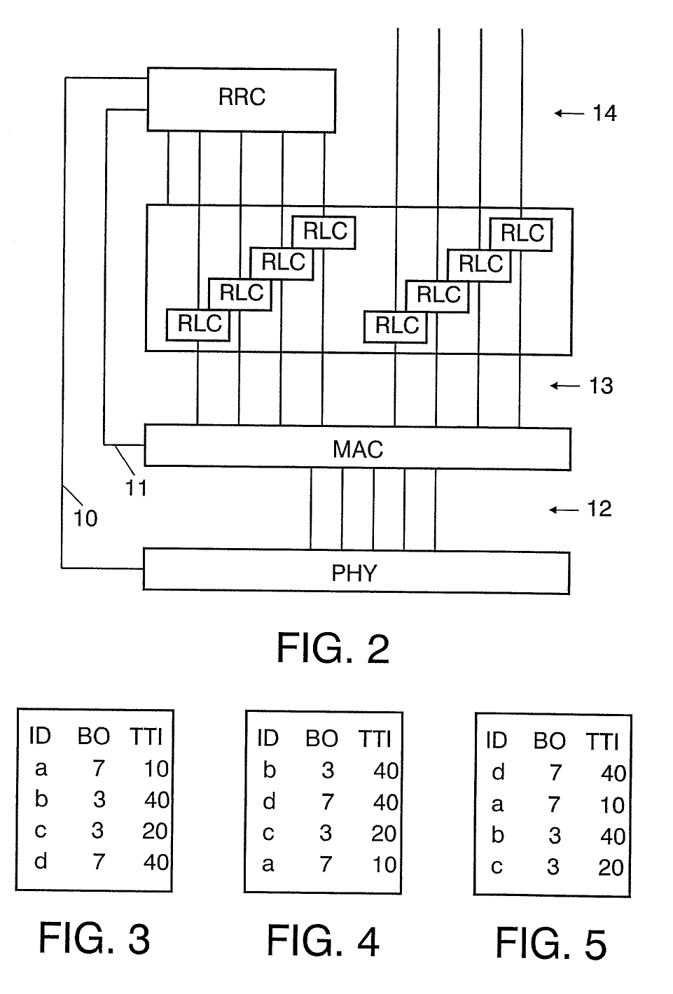

FIG. 1 shows a wireless network having a radio network controller and a plurality of terminals, FIG. 2 shows a layer model for explaining the different functions of a terminal or a radio network controller, and FIGS. 3 to 5 show various lists for explaining the sorting scheme according to the invention.

FIG. 1 illustrates a wireless network, for example. a radio network, having a radio network controller (RNC) 1 and a plurality of terminals 2 to 9. The radio network controller 1 is responsible for controlling all the components participating in the radio traffic such as, for example, the terminals 2 to 9. An exchange of control and useful data takes place at least between the radio network controller 1 and the terminals 2 to 9. The radio network controller 1 sets up a respective connection for transmitting useful data.

As a rule, the terminals 2 to 9 are mobile stations and the radio network controller 1 is permanently installed. However, if appropriate, a radio network controller 1 may also be moveable or mobile.

Radio signals are transmitted in the wireless network by using, for example, the FDMA, TDMA or CDMA method (FDMA=Frequency Division Multiple Access, TDMA=Time Division Multiple Access, CDMA=Code Division Multiple Access) or by means of a combination of the methods.

In the CDMA method, which is a special code-spreading method, an item of binary information (data signal) originating from a user is modulated with a respecting different code sequence. Such a code sequence comprises a pseudo-random square-wave signal (pseudo noise code), whose rate, also termed chip rate, is generally substantially higher than that of the binary information. The duration of a square-wave pulse of the pseudo-random square-wave signal is denoted as chip interval Tc. 1/Tc is the chip rate. The multiplication or modulation of the data signal with the pseudo-random square-wave signal entails spreading of the spectrum by the spread factor Nc=T/Tc, T being the duration of a square-wave pulse of the data signal.

Useful data and control data between at least one terminal (2 to 9) and the radio network controller 1 are transmitted over the channels predefined by the radio network controller 1. A channel is determined by a frequency band, a time domain and, for example in the case of the CDMA method, by a spreading code. The radio link from the radio network controller 1 to the terminals 2 to 9 is denoted as downlink, and from the terminals to the base station it is denoted as uplink. Thus, data are transmitted from the base station to the terminals over downlink channels, and data are transmitted from terminals to the base station over uplink channels.

It is possible, for example, to provide a downlink control channel which is used for the radio network controller 1 to distribute control data to all terminals 2 to 9 before a link set-up. Such a channel is denoted as a downlink broadcast control channel. In order to transmit control data before a link set-up from a terminal 2 to 9 to the radio network controller 1, it is possible, for example, to make use of an uplink control channel which is allocated by the radio network controller 1 and which can, however, also be accessed by other terminals 2 to 9. An uplink channel which can be used by a plurality or all of the terminals 2 to 9 is denoted as a common uplink channel. After a link set-up, for example, between a terminal 2 to 9 and the radio network controller 1, useful data are transmitted over a downlink and an uplink useful channel. Channels which are set up between only one transmitter and one receiver are denoted as dedicated channels. As a rule, a useful channel is a dedicated channel which can be accompanied by a dedicated control channel for transmitting link-specific control data.

In order to be able to exchange useful data between the radio network controller 1 and a terminal, it is necessary for a terminal 2 to 9 to be synchronized with the radio network controller 1. For example, it is known from the GSM system (GSM=Global System for Mobile communication) in which a combination of FDMA and TDMA methods is used, that after the determination of a suitable frequency band with the aid of prescribed parameters, the time-dependent position of a frame (frame synchronization) is determined, with the aid of which the time dependent sequence of the transmission of data is performed. Such a frame is always required for the data synchronization of terminals and base station in TDMA, FDMA and CDMA methods. Such a frame can include various subframes, or form a superframe with a plurality of other consecutive frames.

The exchange of control and useful data via the radio interface between the radio network controller 1 and the terminals 2 to 9 can be explained with the aid of the exemplary layer model or protocol architecture illustrated in FIG. 2 (compare, for example, 3rd Generation Partnership Project (3GPP); Technical Specification Group (TSG) RAN; Working Group 2 (WG2); Radio Interface Protocol Architecture; TS 25.301 V3.6.0). The layer model comprises three protocol layers: the physical layer PHY, the data link layer with the sublayers MAC and RLC (a plurality of embodiments of the sublayer RLC are illustrated in FIG. 2) and the layer RRC. The sublayer MAC is responsible for the medium access control, the sublayer RLC for the radio link control, and the layer RRC for the radio resource control. The layer RRC is responsible for signaling between the terminals 2 to 9 and the radio network controller 1. The sublayer RLC serves for controlling a radio link between a terminal 2 to 9 and the radio network controller 1. The layer RRC controls the layers MAC and PHY via control connections 1 0 and 11. The layer RRC can thereby control the configuration of the layers MAC and PHY. The physical layer PHY provides the MAC layer with transport channels and/or transport connections 12. The MAC layer makes logic channels or logic connections 13 available to the RLC layer. The RLC layer can be reached by applications via access points 14.

Packet units are formed in the RLC layer and packed in the MAC layer into transport blocks which are transmitted by the physical layer over physical channels from the radio network controller to a terminal, or vice versa. Apart from such a multiplex and/or demultiplex function, the MAC layer has the function of selecting suitable transport format combinations (TFC). A transport format combination constitutes a combination of transport formats for each transport channel. The transport format combination describes, inter alia, how the transport channels in the physical layer are multiplexed (time-division multiplex) into a physical channel.

Each transport format has a dynamic and a semi-static part. The dynamic part describes a transport block set (TBS) which is transmitted during a transmission time interval (TTI) in a transport channel, and the semi-static part contains, for example, information on the type of error-correcting coding. The semi-static part is changed only by a reconfiguration of the physical channel. A transport block set is defined as a set of transport blocks which are exchanged between the physical layer and the MAC layer. The size of a transport block is determined by the number of bits of a packet unit of the RLC layer and the number of bits of added control information (header) of the MAC layer.

Only the dynamic part of the transport format is understood below by the term of transport format.

A transmission time interval TTI corresponds to a number of radio frames (RF) and amounts to at least one radio frame. It specifies the number of radio frames over which the interleaving extends. Interleaving is a time-dependent interleaving at the transmitting end of information units (symbols) from consecutive radio frames. The MAC layer supplies a transport block set to the physical layer during each transmission time interval TTI. The transmission time interval is specific of a transport channel and belongs to the semi-static part of the transport format. If, at the beginning of a transmission time interval TTI comprising n radio frames, the physical layer receives from the MAC layer a transport block set which is intended to be transmitted over a transport channel, each transport block of this set is decomposed into n segments (segmentation of transport blocks). The n segments of each transport block are transmitted in the n consecutive radio frames of the transmission time interval. In this case, all n radio frames of the transmission time interval have the same sequence of segments.

The MAC layer serves the purpose of selecting the suitable transport format for each transport channel. When making this selection, account must be taken of the priorities of the logic channels between the RLC and MAC layers, which are termed MAC priority (MAC Logical Priority=MLP) below, the occupancy of the buffers in the RLC layer (Buffer Occupancies=BO), the transmission time intervals TTIs of the transport channels assigned to the logic channels, and subsets of transport format combinations. A buffer in a RLC layer includes packet units which are to be transmitted to the physical layer from the RLC layer via the MAC layer. A subset of the transport format combination is a part of the possible universal set of transport format combinations. Subsets are used in order to limit the number of possible transport format combinations, since the number of bits with which the receiving end is informed of what transport format combination has been used for transmission is likewise limited.

A transport channel (or the logic channel or channels mapped onto it) is (or are) denoted as being inactive in the radio frame when the start of the radio frame does not 5 correspond to the beginning of the transmission time interval of the transport channel. It (or they) are termed active in the other case. In the case of the shortest transmission time interval corresponding to the length of a radio frame of, for example, 10 ms, the assigned transport channel is never inactive, since a transport block records at least this shortest transmission time interval for transmitting its data. A transport channel can be inactive in this sense in the 10 case of longer transmission time intervals (for example 20 ms).

At the beginning of each radio frame, a procedure is executed in the MAC layer which sorts the active logic channels for each radio frame in accordance with the above named criteria:

1. Firstly, sorting is performed according to the highest MAC priority.

2. If the MAC priorities are the same, sorting is performed according to the occupancy of the buffers, the buffers with the most packet units being at the start of the sorted list.

3. If the occupancy of the buffers and the MAC priorities are the same, sorting is performed according to the longest transmission time intervals.

If the procedure has created a list, sorted according to the criteria specified above, with logic channels which have data for transmission, the transmission time interval of the assigned transport channel is checked, starting from the start of the list with the highest MAC priority, in order to find a suitable transport format. It is to be borne in mind in this case that the transport format combination selected at the end leads to the aggregate data rate which does not exceed the overall data rate but can be reached in the case of the prescribed transmit power (and is denoted the data rate condition).

If this transport channel and, consequently, all the logic channels which are mapped onto the transport channel, are inactive in a radio frame, the transport format of the transport format combination selected for the preceding radio frame is to be taken for this transport channel. In the other case, when the current logic channel ((LC_X) is mapped onto an active transport channel (TC_Y), the MAC layer determines the best transport format which the transport channel (TC_Y) can offer the RLC layer in accordance with its transport format sets for the packet units that are to be transmitted in the buffer of the logic channel LC_X (taking account of all the packet units which have already been allocated to the transport channel TC_Y during interrogation of more highly prioritized logic channels, which are likewise mapped onto the assigned transport channel TC_Y). The best transport format is the transport format that permits the highest number of genuine useful data bits on the assigned transport channel TC_Y for the transmission.

There is a need for searching for a transport format combination, since, as a rule, there are a plurality of transport channels onto which a plurality of logic channels are mapped. This can be performed in the following way:

The transport blocks to be transmitted on each transport channel are determined in a first loop. For this purpose, the buffer occupancy BO of each individual active logic channel is queried at the start of each radio frame and added to the number of the blocks to be transmitted in this radio frame of the transport channel onto which the logic channel is mapped.

After this first loop, the precise number of transport blocks that are to be transmitted in this radio frame on each transport channel is known, and the combination of these numbers determines the required transport format combination. This transport format combination is selected if it is present in the set of the transport format combinations prescribed by the radio network controller. However, if it is not present in the set of the given transport format combinations, it is necessary to find in a set in a second loop a transport format combination which is denoted as the most favorable transport combination, and which comes closest to the required one.

Various possibilities are presented for determining the most favorable transport format combination:

A first possibility is denoted as simple distance determination, in which, for example, it is possible to select the transport format combination that has the smallest quadratic deviation (or smallest absolute value deviation) with reference to its components or, in general, the smallest distance—referred to an arbitrary metric—from the required transport format combination. This can lead to the need for the RLC layer additionally to generate filling packet units that are transmitted over a logic channel. This is shown by the following example:

Let the logic channels LC1, LC2 and LC3 be given, which are respectively mapped onto the transport channels TC1, TC2 and TC3. If the buffer occupancies are BO(LC1)=3, BO(LC2)=2 and BO(LC3)=1, 4 transport blocks are to be transmitted over the transport channel TC1, and 2 transport blocks are to be transmitted over the transport channel TC2. If the transport format combination (4,2) is not present among the possible transport format combinations, but only the transport format combinations (5,2) and (3, 1) are present, the transport format combination (5,2) would be selected, since

(5−4)²+(2−2)²=1

yields a smaller quadratic deviation than

(3−4)²+(1−2)²=2

and

|5−4|+|2−2|=1

yields a smaller absolute value deviation than

|3−4|+|1−2|=2.

Since, however, there is then one more transport block (fill transport block) to be transmitted in this case than is actually present, it is necessary to generate a fill packet unit. The generation of fill packet units should be avoided if possible, since fill packet units unnecessarily occupy channel capacity without serving the genuine transmission of useful data.

In the case of the second possibility, presented below, a distance determination is considered, taking account of the required number of fill packet units. This second possibility is denoted as conditional distance determination. The simple distance determination considered above can lead to transport format combinations which in some circumstances require many fill packet units to be transmitted. The following procedure is applied in order to limit the number of fill packet units produced to a value not to be exceeded:

In addition to determining the distance of the required transport format combination, the required proportion of fill packet units is always determined at the same time. Let T be a transport format combination, and T_{erf} the required transport format combination. Then T-T_{erf} produces a vector which can include positive and negative components. The sum of the positive components yields the number of the packet units which are to be transmitted as fill packet units (formally written by Pos (T-T_{erf})e, the operator Pos(v) setting all the negative components of the vector v to zero, and e being the unit column vector), the absolute value sum of the negative components (formally written by Neg(T-T_{erf}) e, the operator Neg(v) setting all the positive components of the vector v to zero) yields the number of the waiting blocks, which cannot be transmitted upon selection of T.

If two transport format combinations which lie close to the required transport format combination by comparison with the remaining transport format combinations differ from one another in the number of the waiting blocks or in the number of the required fill packet units so that, for example, the first transport format combination requires no fill packet units of any sort, but 2 of the waiting blocks are not transmitted on all the transport channels, whereas the other transport format combination requires only one fill packet unit, it then seems to be more sensible, despite the one additional fill packet unit to select the second transport format combination, since this achieves a substantially better throughput.

Consequently, in addition to the distance to the required transport format combination, the values Pos (T-T_{erf})e for the number of the fill packet units and Neg(T-T_{erf})e for the number of the waiting packet units are determined. If Pos (T-T_{erf})e exceeds a specific value (for example 2 fill packet units), the transport format combination is not further taken into account. Moreover, it is also possible to express the relationship of the number of the required fill packet units to the actually transmitted transport blocks for useful data:the transport blocks for useful data are yielded as [T_{erf}+Neg(T-T_{erf})]e so that the proportion of fill packet units is given by Pos (T-T_{erf})e[T_{erf}+Neg(T-T_{erf})]e, and a transport format combination is no longer taken into account during the search if this proportion exceeds a prescribed percentage (for example 10%).

A third possibility of determining the favorable transport format combination is presented below and takes account of the conferring of the priorities of the logic channels. This can be explained using the following example:

Let 6 logic channels LC1 to LC6 be given, which are mapped onto 3 transport channels.

The logic channel LC1 is mapped onto the transport channel TC1,

the logic channel LC2 is mapped onto the transport channel TC1,

the logic channel LC3 is mapped onto the transport channel TC2,

the logic channel LC4 is mapped onto the transport channel TC3,

the logic channel LC5 is mapped onto the transport channel TC2, and

the logic channel LC6 is mapped onto the transport channel TC3.

Let the buffer BO(LC1) assigned to the logic channel LC1 be occupied by 4 packet units,

let the buffer BO(LC2) assigned to the logic channel LC2 be occupied by 2 packet units,

let the buffer BO(LC3) assigned to the logic channel LC3 be occupied by 3 packet units,

let the buffer BO(LC4) assigned to the logic channel LC4 be occupied by 8 packet units,

let the buffer BO(LC5) assigned to the logic channel LC5 be occupied by 5 packet units, and

let the buffer BO(LC6) assigned to the logic channel LC6 be occupied by 9 packet units.

The indices of the logic channels also express their priority, 1 signifying the highest priority. It is assumed, furthermore, (without limitation of generality) that the numeration of the transport channels is performed in such a way that the transport channel TC1 always conveys packet units of the logic channel LC1, the transport channel TC2 conveys packet units of at least one logic channel which has a higher priority than all the logic channels which will convey packet units or transport blocks of the transport channels TC3, TC4, . . . , the transport channel TC3 conveys packet units of at least one logic channel which has a higher priority than all the logic channels which will convey packet units or transport blocks of the transport channels TC4, TC5, . . . etc.

Consequently, the transport channel TC1 is to transport (4+2)=6 transport blocks, the transport channel TC2 is to transport (3+5)=8 transport blocks, and the transport channel TC3 is to transport (8+9)=17 transport blocks. The required transport format combination would therefore be (6, 8, 17).

In order to take account of the priorities, the set of the given transport format combinations is restricted so that all the transport format combinations satisfy the condition TF1>6, TF2>3, TF3>8, TF1, TF2 and TF3, respectively, representing transport formats of TC1, TC2 and TC3, respectively. In this condition, it is firstly required that TF1>6, so that the two logic channels that are most highly prioritized and mapped onto the transport channel TC1 are correctly treated with regard to their priority. If the condition for the transport channel TC1 cannot be satisfied by the existing transport format combination, the condition is weakened to TF1>4 (minimum condition for a single logic channel). This means that only the logic channel LC1 with the highest priority is still taken into account correctly. In, for example, TF2>3, TF3>8 are likewise minimum conditions for a single logic channel.

If it is also impossible to satisfy the minimum condition for a single logic channel, because the transport formats of a transport channel permit transmission of a few transport blocks only, the following minimum case is assumed for this transport channel: if the transport formats of the transport channel TC3 permit the transmission of only 6 transport blocks, while the remaining transport channels satisfy the conditions, the overall condition with the aid of which the set of the given transport format combination is limited runs: TF1>4, TF2>3, TF3=6. In the set thus limited, the determination of distance (first or second option) is then used to determine the transport format combination that lies closest to the required one (specifically, the transport format combination (6, 8, 17)).

Adopting only (6, 8, 4) and (2, 8, 12) as possible transport format combinations, in the present case the pure distance determination would lead to a selection of the transport format combination (2, 8, 12), because Dist[(6, 8, 17), (6, 8, 4)]=0+0+13>4+0+5 =Dist[(2, 8, 12), (6, 8, 17)].

This selection would, however, lead to a priority inversion, since the logic channels LC3 and LC5 given lower priority are now capable of sending more data (the logic channel LC3 can transmit the 3 waiting packet units, and the logic channel LC5 can even transmit the 5 waiting packet units) than is the most highly prioritized logic channel LC 1 (the logic channel LC 1 can transmit only 2 packet units, although 4 packet units are waiting in the assigned buffer). The logic channel LC2 is not operated at all, although it is more highly prioritized than the logic channels LC3 and LC5. By contrast, the limitation of the transport combination set with the condition TF1>4, TF2>3, TF3>8 would lead to the transport format combination (6, 8, 4), which correctly takes account correctly of the priorities.

In the general case, the condition for the limitation of the set of the given transport format combinations is to be formulated as follows for the purpose of taking account of the priorities: let the logic channels LC(Fᵢ,) LC(Fᵢ+1), . . . LC(Fᵢ+Mₗ−1) be the uninterrupted list of the most highly prioritized logic channels which are mapped onto the transport channel TCi, that is to say, further logic channels which are mapped onto the transport channel TCi have an index which is greater than Fᵢ+Mᵢ. i, Fᵢ and Mᵢ are natural numbers in this case. (By definition Fᵢ=Fₗ=1 for i=1.)

If, for example, the logic channel LC1 is mapped onto the transport channel TC1,

the logic channel LC2 is mapped onto the transport channel TC1,

the logic channel LC3 is mapped onto the transport channel TC2,

the logic channel LC4 is mapped onto the transport channel TC2,

the logic channel LC5 is mapped onto the transport channel TC2,

the logic channel LC6 is mapped onto the transport channel TC1,

the logic channel LC7 is mapped onto the transport channel TC3,

the logic channel LC8 is mapped onto the transport channel TC3,

the logic channel LC9 is mapped onto the transport channel TC4 and

the logic channel LC10 is mapped onto the transport channel TC3, then

Fₗ=1, Mₗ=2, F₂=3, M₂=3, F₃=7, M₃=2, F₄=9, M₄=1.

The set of the given transport format combinations is limited for taking correct account of the priorities according to the following conditions, beginning with i=1:

TFi≧Σ_{j=Fi}^{F}^{ᵢ}^{+M}^{ᵢ}⁻¹BO(LCj)for all TCi where i=1,2, . . . , N

(N specifies the number of the transport channels.).

If the condition for the transport channel TCi cannot be satisfied by the set of the given transport format combinations, a check is made as to whether it is possible by omitting the respectively most lowly prioritized logic channel in the sum to satisfy the resulting condition of transport format combinations in the set of the given transport format combinations, that is to say whether the above named conditions can be replaced by

TFi≧Σ_{j=F}_{ᵢ}^{F}^{ᵢ}^{+M}^{ₗ}⁻²BO(LCj),

that is to say, only the first Mᵢ−1 most highly prioritized transport channels, which are mapped onto the transport channel TCi are taken into account, or by

TFi≧Σ_{j=D}_{ᵢ}^{F}^{ᵢ}^{+M}^{ᵢ}⁻³BO(LCj),

that is to say, only the first Mᵢ−2 most highly prioritized transport channels, which are mapped onto the transport channel TCi are taken into account, and so on up to the condition TFi>BO(LC(Fᵢ)),

that is to say, only the most highly prioritized logic channel, which is mapped onto the transport channel TCi, is taken into account.

If, finally, it is also not possible for TFi>BO(LC(Fᵢ)) to be satisfied in the set of the given transport format combinations (minimum condition for a single logic channel), the condition is replaced by the minimum condition TFi=X, X being the greatest number of packet units or transport blocks which can be transmitted on the transport channel TCi in accordance with the set of possible transport format combinations. X is then always smaller than BO(LC(Fᵢ)).

If a condition that can be satisfied has been found for the transport channel TCi, the set, so far limited, of the transport format combinations is further limited with the aid of this condition and the procedure then continues with TC(i+1), that is to say, firstly the condition that can be satisfied is determined and then this condition is used to limit the set of the transport format combinations that has so far been found.

After consideration of all the transport channels, the set of possible transport format combinations is suitably limited taking account of the priorities. In the limited set, it is now possible to use distance determination (according to a first and second option for determining the most favorable transport format combination) to determine that transport format combination which is at the smallest distance from the required transport format combination, if the remaining set does not contain only one element.

A fourth option, described below, for determining the most favorable transport format combination takes account of the requirement not to insert filling packet units, and of the priorities of the logic channels. The procedure is as follows when the filling packet units are completely excluded:

If, as in the above named example, the required transport format combination is (6, 8, 17), the set of possible transport format combinations is firstly limited to those transport format combinations that permit exactly 6 packet units or transport blocks to be transmitted over the transport channel TC1. If there is no such transport format combination, the limitation is performed in relation to such combinations as permit exactly 5 packet units or transport blocks to be transmitted over the transport channel TC1. If these do not exist either, the number of packet units or transport blocks which are to be transmitted over the transport channel TC1 is further reduced until the number of the blocks present for the transmission corresponds to the first component (or first transport format) of a transport format combination in the set of the given transport format combinations.

The subset of the transport format combination which has been found is now limited to those transport format combinations which permit exactly 8 packet units or transport blocks to be transmitted over the transport channel TC2. If there is no corresponding transport format combination, the subset is limited to those transport format combinations which permit exactly 7 packet units or transport blocks to be transmitted over the transport channel TC2. If these do not exist either, the number of packet units or transport blocks which are to be transmitted over the transport channel TC2 is further reduced until the number of the packet units or transport blocks present for the transmission corresponds to the second component of a transport format combination in the set of the given transport format combinations.

The transport format combination that permits the greatest number of packet units or transport blocks, but no more than 17 packet units or transport blocks, to be transmitted over the transport channel TC3 is then selected in the remaining subset. This ensures that the transport channel TC1 which is assigned the most highly prioritized logic channel always transports the highest possible number of packet units or transport blocks, assuming that there is no need to send filling packet units. In the case of unfavorable selection of the set of the given transport format combinations, this can, however, lead to a poor throughput, the consequence being a growth in the buffers of the individual logic channels. Such a response should be avoided by the radio network controller by selecting a suitable transport format combination.

It can happen that it is always only the most highly prioritized logic channels that come into play in the data transmission because of the selection of the given transport format combinations and the developing buffers. In order to avoid this, the priority list can be changed temporarily in all the radio frames of two respective previously fixed, non-adjacent (marked) transmission time intervals such that, for example, the logic channel with the lowest priority in this radio frame is allocated the highest priority, the result being that the blocks (or a portion thereof) waiting in its buffer are certainly transmitted.

In this case, the sum is first formed over the total number of transport blocks transmitted between two consecutive (in the above-named sense) marked transmission time intervals. A maximum proportion (in percentage terms, for example) of the number of transport blocks which the most highly prioritized logic channel may transmit by a temporary change in priority is also prescribed. The MAC layer uses the sum and this proportion to determine the absolute number of transport blocks of the logic channel with the lowest priority which can be transmitted in the subsequent marked transmission time interval with the highest priority. By also taking account of other lowly prioritized logic channels, it can be ensured that on average a given percentage of the transport blocks of the logic channels with the lowest priority is transmitted in any case.

After a complete transport format combination has been calculated for a radio frame, the MAC layer requests the RLC layer to send the computed number of transport blocks to the MAC layer. Subsequently, the generated transport block sets (one set for each transport channel) are transmitted to the physical layer. The physical layer then inserts the received transport block sets into a radio frame in accordance with the selected transport format combination, while taking account of the segmentation of transport blocks if the transmission time interval TTI includes more than one radio frame.

The above described procedure for selecting an optimum transport format combination for the next radio frame firstly generates a list sorted according to three criteria. As illustrated, the first criterion is the sorting of the logic channels according to their MAC priority. The size of the buffers in the RLC layer is considered only if some logic channels have the same logical priority. The longest transmission time interval is the third criterion if the first two parameters are equal.

Since the priority of the MAC layer and the transmission time interval are semi-static parameters (in general, the parameter can be changed only by a transport channel reconfiguration), but the size of the buffers varies from radio frame to radio frame, the above named sorting can be carried out according to the invention with the same sorting result in accordance with the following scheme:

After a transport channel reconfiguration, which can include, for example, the addition of a further transport channel or the removal of an existing transport channel, the logic channels are

1. sorted once according to their MAC priority (MLP), and

2. sorted once for all logic channels with the same MAC priority (MLP) according to their transmission time interval (TTI) in decreasing length.

At the beginning of each radio frame, the then active logic channels having the same MAC priority in the ordered list are then resorted only according to the occupancies of the buffers (longest buffer first), the length of the transmission time interval (TTI) then being ignored. If a lowly prioritized logic channel is to be preferred in a radio frame (as described above), the sorting according to MLP must be changed correspondingly for this radio frame. In accordance with this sorting, the MAC layer then interrogates the RLC layer of the individual logic channels as to the number of the packet units or transport blocks to be transmitted, and selects the most favorable available transport format (that is to say, the one that permits the highest data rate). The sorting thus defined therefore saves two sorting steps at the beginning of each radio frame.

An example of this sorting scheme is shown in FIGS. 3 to 5. FIG. 3 illustrates an unsorted list with the same priorities of the MAC layer, ID being an identification designation for the logic channels, BO being the occupancy of the buffer of packet units which are to be transmitted over an assigned logic channel, and TTI being the transmission time interval of the assigned transport channel. The unsorted list has four logic channels with ID=a, b, c and d. The logic channel with the ID=a is assigned BO=7 and TTI=10, the logic channel with the ID=b is assigned BO=3 and TTI=40, the logic channel with the ID=c is assigned BO=3 and TTI=20, and the logic channel with the ID=d is assigned BO=7 and TTI=40. FIG. 4 shows the list which is sorted in accordance with the longest transmission time intervals TTI. Subsequently, the logic channels are sorted according to the size of the buffers BO, no consideration being given to the transmission time intervals TTI. This sorted list is shown in FIG. 5.

1. A wireless network having a radio network controller and a plurality of assigned terminals which are provided each for transmitting transport blocks formed from packet units of a logic channel on a transport channel which is assigned a transmission time interval from at least one radio frame, and which is active when the beginning of its transmission time interval and of a radio frame correspond, and which are provided for forming at least one transport format combination, which specifies the transport blocks provided for transmission on each transport channel, so that
a required transport format combination is to be determined which includes as transport format the respective packet units awaiting a transmission in the assigned transport channel, and
the transport format combination that corresponds to the required transport format combination or comes closest to it is to be selected from a set of prescribed transport format combinations.

2. A wireless network as claimed in claim 1, characterized in that, if the required transport format combination is not included in the set of prescribed transport format combinations, the radio network controller or a terminal is provided for selecting the transport format combination that has the smallest distance with reference to a metric relating to the required transport format combination.

3. A wireless network as claimed in claim 2, characterized in that, in the case of a selection of a transport format combination with the aid of which more than the required transport blocks are to be transmitted, the radio network controller or a terminal is provided for filling up the absent transport blocks by means of filling transport blocks without useful data.

4. A wireless network as claimed in claim 3, characterized in that, the radio network controller or a terminal is provided for selecting the transport format combination in the case of which a specific number of additional filling transport blocks, or in the case of which the ratio of a number of filling transport blocks to actually transmitted transport blocks with useful data is not exceeded.

5. A wireless network as claimed in claim 1, characterized in that, if the required transport format combination is not included in the set of prescribed transport format combinations, the radio network controller or a terminal is provided for the purpose of limiting, in a fashion based on specific conditions, the set of transport format combinations in the sequence of the priority of the logic channels, and is provided for the purpose of selecting from the limited set the transport format combination that has the smallest distance with reference to a metric relating to the required transport format combination.
